(19) United States
(12) Patent Application Publication
(10) Pub. No.: US 2013/0175996 A1
(43) Pub. Date: Jul. 11, 2013

(54) CHARACTERIZING BATTERY DISCHARGE UNDER DIFFERENT LOADS

(71) Applicant: Juval Lowy, Los Gatos, CA (US)

(72) Inventor: Juval Lowy, Los Gatos, CA (US)

(73) Assignee: IDesign, Inc, Los Gatos, CA (US)

(21) Appl. No.: 13/344,481

(22) Filed: Jan. 5, 2012

(51) Int. Cl. H02J 7/00

(52) U.S. Cl. 320/134

(57) ABSTRACT

A storage battery may be characterized from measurements of voltage versus time for different loads. Each measurement for a given load value may be fitted to a corresponding discharge function. The corresponding discharge functions may be applied to specific end voltage values to determine discharge time data for given loads. The discharge data may be interpolated to provide additional data points for discharge time to a particular voltage as a function of load. The resulting set of discharge time data may be fit to a discharge time function. The discharge time function may be used to fill in voltage versus time curves for intermediate load values to produce a computer model for time to a particular voltage.

### FIELD OF THE INVENTION

This invention generally relates to electrical storage batteries and more particularly to methods and apparatus for determining the time to discharge a battery from a given initial voltage to a given final voltage under a given load, and the voltage after a given time and load.

### BACKGROUND OF THE INVENTION

A rechargeable battery or storage battery is a group of one or more electrochemical cells. Storage batteries are also known as secondary cells because their electrochemical reactions are electrically reversible. Rechargeable batteries come in many different shapes and sizes, ranging anything from a button cell to megawatt systems connected to stabilize electrical distribution networks. Several different combinations of chemicals are commonly used, including: lead-acid, nickel cadmium (NiCd), nickel metal hydride (NiMH), lithium ion (Li-ion), and lithium ion polymer (Li-ion polymer).

Rechargeable batteries are commonly used for automobile starters, portable consumer devices, light vehicles (such as motorized wheelchairs, golf carts, electric bicycles, and electric forklifts), tools, and other applications requiring uninterruptible power supplies such as off-the-grid houses or occasionally connected house. Emerging applications in hybrid electric vehicles and electric vehicles are driving the technology to reduce cost and weight and increase lifetime.

Rechargeable batteries are used in grid energy storage systems for load leveling, where they store electric energy for use during peak load periods. By charging batteries during periods of low demand and returning energy to the grid during periods of high electrical demand, load-leveling helps eliminate the need for expensive peaking power plants and helps amortize the cost of generators over more hours of operation. Rechargeable batteries are also used to store electrical power generated by renewable energy systems, such as photovoltaic arrays during the day to be used at night or by wind turbine to be used when the wind is not blowing.

The active components in a secondary cell are the chemicals that make up the positive and negative active materials, and an electrolyte. The positive and negative active materials are made up of different materials, with the positive active material exhibiting a reduction potential and the negative active material having an oxidation potential. The sum of these potentials is the standard cell potential or voltage.

During charging, the positive active material is oxidized, producing electrons, and the negative material is reduced, consuming electrons. The electrons constitute the current flow in the external circuit. The electrolyte may serve as a simple buffer for ion flow between the electrodes, as in lithium-ion and nickel-cadmium cells, or it may be an active participant in the electrochemical reaction, as in lead-acid cells.

The energy used to charge rechargeable batteries usually comes from a battery charger operating on alternating current (AC), e.g., from a standard electrical outlet. Chargers may take from a few minutes to several hours to charge a battery. Fast chargers must have multiple ways of detecting full charge (voltage, temperature, etc.) to stop charging before onset of harmful overcharging. There is also direct current charging, such as charging from photovoltaic solar panels, micro hydro turbines and some wind turbines.

Batteries are also subject to damage from being too fully discharged due to reverse charging if they are fully discharged. It is therefore desirable to be able to determine or estimate when a battery is fully discharged. It is also useful to be able to simulate and project the time it will take to discharge the battery under given load, as a way of forecasting range of an electric vehicle, or to optimize price-wise the scheduling charge of storage batteries when using the grid. Similarity, a house management system can schedule running various alliances against the batteries by estimating the remaining capacity of the batteries. The discharge time is a factor of the initial voltage, the load and other factors such as temperature. There are a number of theoretical models for the behavior of a battery that can be used to predict the time to discharge a storage battery under given load conditions. However, these models are either too complex or too simplistic or inaccurate.

It is within this context that embodiments of the present invention arise.

### BRIEF DESCRIPTION OF THE DRAWINGS

Other objects and advantages of the invention will become apparent upon reading the following detailed description and upon reference to the accompanying drawings in which:

FIG. 1 is a schematic diagram of a battery characterization apparatus according to an embodiment of the present invention.

FIG. 2A, FIG. 2B, and FIG. 2C are graphs plotting battery voltage as a function of time during battery discharge under different load conditions.

FIG. 3 is a graph showing fitted curves for the plots in FIGS. 2A-2C.

FIG. 4A is a graph showing time to discharge an off-the-grid battery to specific voltages as a function of load.

FIG. 4B is a graph showing time to discharge an off-the-grid battery to specific voltages as a function of load with interpolated values.

FIG. 5A is a graph of voltage versus time for discharging an off-the-grid house battery for loads from 100 W to 500 W.

FIG. 5B is a graph of voltage versus time for discharging an off-the-grid house battery for loads from 500 W to 1000 W.

FIG. 6 is a graph of off-the-grid battery capacity versus load for a battery characterized in accordance with an embodiment of the present invention.

FIG. 7 is a flow diagram illustrating a method for battery characterization according to an embodiment of the present invention.

FIG. 8A is an example of a screen shot generated with a computer program implement a battery characterization method according to an embodiment of the present invention.

FIG. 8B is an example of another screen shot generated with a computer program implement a battery characterization method according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### INTRODUCTION

According to embodiments of the present invention, a battery may be characterized in terms of its time to discharge from a given start voltage to a given end voltage under a specific load. To characterize a battery, measurements of battery voltage as a function of time during battery discharge for different power loads may be fitted to discharge functions. The discharge functions may be applied to specific end voltage values determine a first set of data for the time for a battery that has been charged to a given starting voltage to discharge to a particular end voltage for a given load. The first set of data may be interpolated to provide additional data points to produce a plurality of second sets of data for discharge time to a particular voltage as a function of load. Each second set of data of discharge time to a particular voltage as a function of load can be fitted to a function. The function may be an odd order polynomial (e.g., 3^{rd} order, 5^{th} order, etc.), a power function, or some combination of a polynomial and a power function.

Using the fitted function it is possible to fill in voltage versus time curves for intermediate load values to produce a model for time to a particular voltage as a function of load. This can be done by using the fitted functions for voltage versus time measured for each load to determine the time to reach a sufficient number of selected voltages over the measurement range. The results can then be expressed in terms of time to particular target voltages versus load. These results can be interpolated to obtain times for intermediate load values to obtain a sufficient number of points to model for each target voltage the time to the target voltage as a function of load.

Using the resulting models for time to a particular target voltage as a function of load and voltage over time for different loads one can calculate battery capacity starting from fully charged to fully discharged as a function of load. Using weighting between curves for known loads and/or voltages it is possible to determine a voltage versus time curve for any load and the time to discharge curve for any voltage. The time versus voltage curves may be implemented automatically in a computer program.

The result of the foregoing battery characterization operations is a program that allows one to (a) specify any load, start voltage and target voltage and determine how long it takes for the battery to discharge from the start voltage to the target voltage; (b) specify any load, start voltage and target time to determine what the target voltage will be at the target time; or (c) specify a load and target voltage and determine the battery capacity. Binary search searches and recursive search algorithms may be used to speed up the calculations.

Once a battery has been characterized as described above it may be operated in accordance with the characterization. For example, the start voltage and load may be measured or otherwise determined. The start voltage and load may be entered into the program, which calculates the time to discharge based on a known target voltage, which may be specified by the battery manufacturer or which may depend on the nature of the load or the application. The battery may be operated using an automated system that changes the state of battery operation once the discharge time is reached after starting discharge under the load. The change in state may involve, e.g., closing a switch to disconnect the load from the battery and/or to connect the battery to a charger to begin a charge cycle.

Alternatively, the load, start voltage, and a target time may be entered as inputs to the program and a target voltage at the target time may be calculated. The calculated target voltage may be compared against an acceptable target voltage to determine whether the battery may be safely operated up to the target time. The battery may then be operated automatically until the target time if it is determined that the target voltage is a safe voltage.

In yet another alternative, a load and target voltage may be entered into the program, which may then calculate the battery capacity. The calculated battery capacity may be compared against an estimated capacity needed to power a given task to determine whether the battery has sufficient capacity to complete the task, such as can an electric vehicle reach its destination, or can a house battery power the load for the requested time. The battery may then be operated automatically if it is determined that the battery has sufficient capacity for the task.

### EXAMPLES

### Battery Characterization

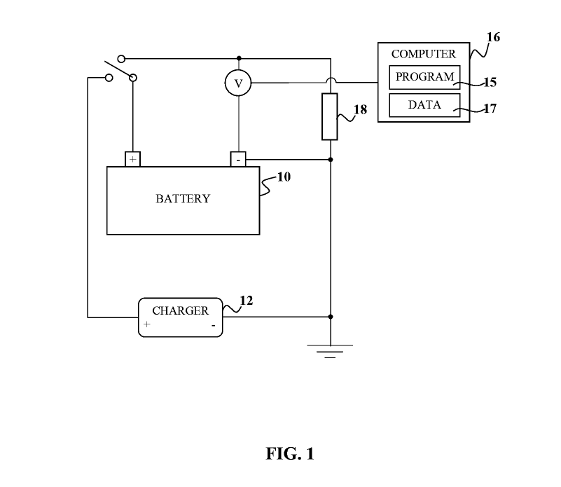

A battery may be characterized using data from a relatively small number of controlled discharge experiments. The experimental set up may be as illustrated schematically in FIG. 1. Specifically, a battery 10 may be charged by a charger unit 12 to a known voltage, which may be measured by a voltage meter 14 and recorded in digital form with the aid of a computer 16.

By way of example, and not by way of limitation, the 10 may be made up of multiple batteries in a battery bank.

By way of example, and not by way of limitation, the charger unit 12 may be in the form a solar array. The battery may then be connected to a load device 18 through a switch 20. The load device 18 may be configured to draw a constant power from the battery 10. The term “load” is often used herein to refer to the power drawn by the battery. The term load is also often used conventionally to refer to the device that draws the load. To avoid confusion, the term “load device” is used herein to refer to the device that draws the load. By way of example, and not by way of limitation, the load device may be a bank of incandescent lights (e.g., halogen lights) to create load with a power factor of 1.0.

Each experiment may start with the batteries fully charged by for a few days, i.e., more than just one day of full charge, to get a good common baseline starting state. The battery may be disconnected from the charger after it has been charged to a given starting voltage V₀. The battery may then be connected to the load device 18 and run at approximately constant load until it is discharged to a safe discharge voltage. The level for a safe discharge will vary depending on the type of battery; however, this level is often specified by the battery manufacturer. By way of example, a battery bank may include 16 Rolls model S-530 Lead Acid, 6V 530AH batteries from Surette Battery Company of Springhill, Nova Scotia, Canada. The batteries may be connected in two parallel strings of 8 batteries connected serially, so that an overall voltage of the battery bank is nominally 48V, and may be charged to 50 volts and discharged to between 45.8 volts and 46 volts. The discharge measurements are repeated for different load values, e.g., 100 Watts, 500 Watts and 1000 Watts.

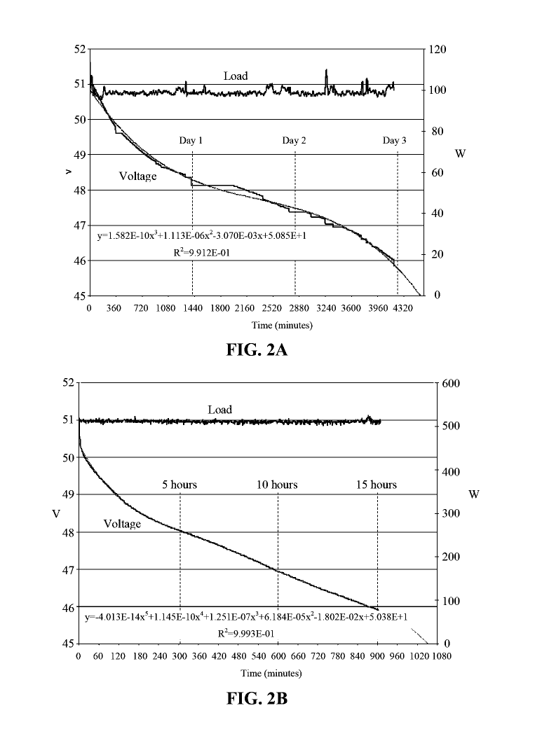

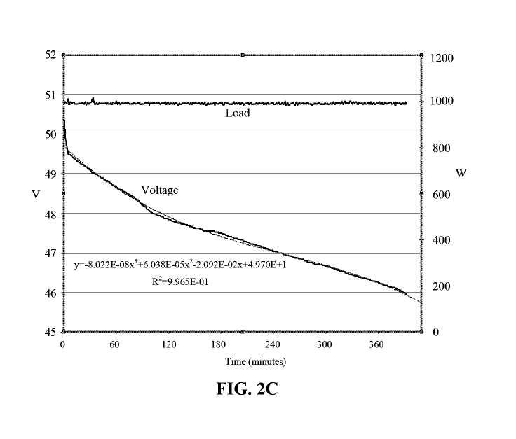

The computer may be a general purpose computer, e.g., having a processor, memory, input output functions, clock, cache and other features commonly found in computers. The computer may include a program 15 to run on the processor and data 17, which may be stored in a memory affiliated with the computer. The computer 16 may plot or otherwise record the battery voltage data as a function of time. A function may be calculated from the battery voltage data as a function of time. For convenience, this function is referred to herein as a discharge function. For each load value, a corresponding discharge function may be calculated, e.g., by least-square fit to a polynomial or other mathematical function with an R² of at least 90% or better and more preferably 99% or better. In the case of the curve for a load of 500 W shown in FIG. 2B, a fifth order polynomial turned out to be a perfect fit discharge function. However, this is only one example, and should not be construed as a hard limitation on the invention.

The “S” nature of the classic discharge curves (voltage versus time) for different constant loads may be seen from FIG. 2A, FIG. 2B, and FIG. 2C. Each graph also shows the load as a function of time. It is noted that there even if there is some fluctuation in the load, e.g., as shown in FIG. 2C, the load may be regarded as an “approximately constant load” if the fluctuations tend to average out over the measurement period. In general, the voltage drops steeply for a brief period, then less steeply for a longer period and then steeply again. It is desirable to avoid discharging the battery (or battery bank) below some safe level. For example in FIGS. 2A-2C, the fact that the final drop is under 46V (even with a load as little as 100 W) is a clear indication the batteries used for these measurements should not be drained below 46V.

To avoid this, the computer 16 may be configured to trigger the charger 12 to charge the battery 10 if the voltage falls below some threshold (e.g., 47 volts) for a sufficiently long period (e.g., 24 hours).

Although FIG. 2A, FIG. 2B and FIG. 2C do not show it, the coefficients of the polynomials used to fit the voltage versus time data were calculated to fourteen decimal places. It was determined that if fewer decimal places were used, the curve fitting was unacceptable due to accumulated errors.

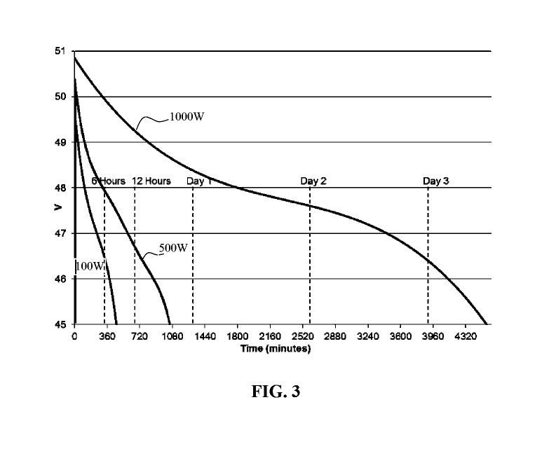

Difficulties in predicting and modeling battery discharge behavior become apparent when the three discharge functions obtained from the data in FIGS. 2A-2C are plotted on the same graph and extended. The resulting graph shown in FIG. 3 demonstrates the highly non-linear nature of the behavior of the discharge curves as a function of load. For example, the discharge curve for the 500 W load is much closer to the 1000 W discharge curve than to the 100 W discharge curve, even though the 500 W load is roughly halfway between 100 W and 1000 W. Furthermore, the behavior of the discharge curves for the 500 W and the 1000 W loads is a much more drastic “straight down” curve, as opposed to the shallow ‘S’ curve for the 100 W load.

Embodiments of the invention provide a model based on measurements for a relatively small number of load values that predicts the end voltage level for any given load after any amount of time, for any given starting voltage, or the inverse question: how long it will take for a battery to discharge from a given starting voltage to a given end voltage for a given load.

An advantage of the model produced according to embodiments of the present invention, is that it avoids problems associated with the boundary conditions describing the state of the batteries, making the theoretical model simply unapproachable.

Such a model may be generated from discharge curve data and/or discharge functions for a relatively small number of load values (e.g., three, including a low load, a high load, and a middle range load). Reducing the number of load values can be quite advantageous when the discharge measurements require a day or more for each load value. The model may be generated starting from the discharge functions obtained from the voltage versus time data. First the discharge function for each measured load may be sampled to determine the discharge time for the battery 10 to reach specific predetermined voltage levels. By way of example, discharge times to six different voltage levels (45 V, 46 V, 47 V, 48 V, 49 V and 50 V) may be determined for each load value. For the discharge curves described above, the results are listed in Table I below and the values in the table are time in minutes.

TABLE I

Voltage

| Load | 45 | 46 | 47 | 48 | 49 | 50 |
|---|---|---|---|---|---|---|
| 100 | 4552 | 4126 | 3450 | 1804 | 814 | 309 |
| 500 | 1053 | 873 | 589 | 315 | 111 | 24 |
| 1000 | 462 | 386 | 247 | 112 | 37 | 0 |

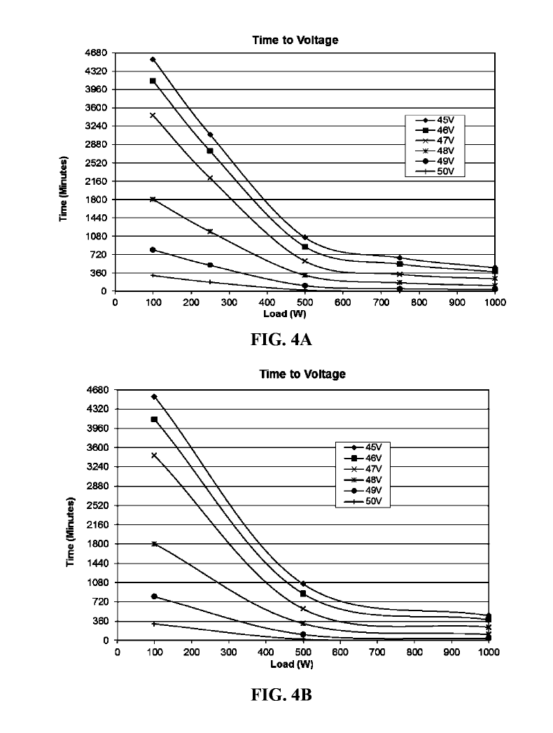

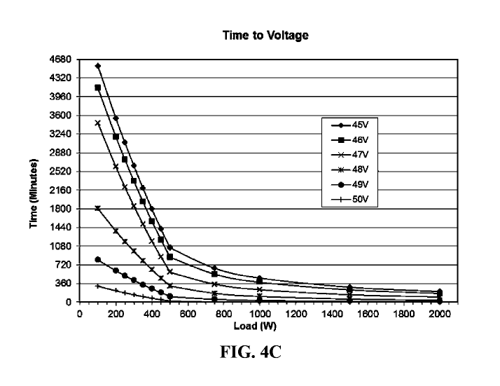

This data may be re-plotted to give curves of time to each given voltage as a function of load. The resulting time versus load curves are depicted in FIG. 4A

Next, the time versus load data may be interpolated, e.g., using a spline function, to obtain time values for each voltage for load values intermediate the load values for the measurements. For example, one can measure from FIG. 4A between the 100 W and 500 W when the 250 W load would reach each voltage line, and between 500 W and 1000 W measured on the chart when the 750 W would reach each voltage line. The results are listed in Table II below.

TABLE II

| | Voltage | | | | | | | |
|---|---|---|---|---|---|---|---|---|
| Load | 45 | 46 | 46.5 | 47 | 47.5 | 48 | 49 | 50 |
| 100 | 4552 | 4126 | 3845 | 3450 | 2802 | 1804 | 814 | 309 |
| 250 | 3075 | 2750 | 2520 | 2220 | 1795 | 1170 | 510 | 180 |
| 500 | 1053 | 873 | 723 | 589 | 459 | 315 | 111 | 24 |
| 750 | 657 | 535 | 432 | 333 | 245 | 168 | 52 | 4 |
| 1000 | 462 | 386 | 327 | 247 | 168 | 112 | 37 | 0 |

Interpolating the data in Table II provides five data points for each voltage line instead of the original three. FIG. 4B shows the time versus load data from FIG. 4A along with the additional data points determined from the spline functions. Note that each curve now has five data points, which is much better than three data points for calculating a trend curve using a least-square regression technique. Using the revised data from Table II one can determine a best fit function (best R² value) for the time versus load for each given voltage. For convenience, such best fit functions are referred to as discharge time functions.

In the example described by the data in Table II above, the best fit (best R²) discharge time function would use one formula (F₁(X)) for each voltage value up to a cutoff load value and a different formula (F₂(X)) beyond the cutoff load value.

The cutoff value may be determined from inspection of various R² values. Past the “knee” in the curve, it was observed that the discharge function behaved much more like a power function than a polynomial. It is useful to pick a point around the knee, and measurement point in the middle (500 W) provided a simple solution (and the R² values agreed).

By way of example, and not by way of limitation, in the case of the data in Table II, the best fit was a polynomial for up to 500 W, and a power function from 500 W. In general the polynomial may be of any integer order N and may have the general form C_{N}X^{N}+C_{N-1}X^{N-1}+ . . . +C₂X²+C₁X+C₀. Where the Cᵢ are coefficients and X represents the load (e.g., in Watts). The power function may have the form AX^{b}, where A is a coefficient, b is an exponent, and X represents the load (e.g., in Watts).

By way of example, and not by way of limitation, the polynomial may be a second order polynomial of the form:

C₂X²+C₁X+C₀, where C₁, C₂, and C₃ are coefficients that can be determined by a curve fitting program.

By way of specific numerical example, for the 45V line, the best fit polynomial and power formula were are given by:

F₁(X)=0.0043967X²−11.386X+5646.6(for 100<X≦500)

F₂(X)=1582550X^{-1.177}(for 500<X)

The selection of the polynomial and power function and the determination of the cutoff load value may be automated, through the use of specially programmed software. Alternatively, the functions, and cutoff load value may be determined manually using commercially available spreadsheet and laboratory simulation programs

It is noted that for the best results it is desirable to compute the coefficients in F₁(X) and F₂(X) to at least fourteen decimal places.

Using the formula for each voltage value one can plot time versus load curves for each voltage over a whole range of load values, e.g., from 0 to 2000 W in FIG. 4C. Using the estimated formulas where the only variable is the load one can calculate for any arbitrary load how long it will take it to reach the specific voltage levels of the chart above. An example of such calculations based on the formulas for the curves shown in FIG. 4C, is listed in Table III below, which expands on the data in Table III by including calculated data points for loads of 200 W, 300 W, 350 W, 400 W, 450 W, 1500 and 2000 W.

TABLE III

Voltage

| Load | 45 | 46 | 47 | 48 | 49 | 50 |
|---|---|---|---|---|---|---|
| 100 | 4552 | 4126 | 3450 | 1804 | 814 | 309 |
| 200 | 3545 | 3188 | 2609 | 1371 | 607 | 220 |
| 250 | 3075 | 2750 | 2220 | 1170 | 511 | 180 |
| 300 | 2627 | 2333 | 1852 | 979 | 422 | 143 |
| 350 | 2200 | 1937 | 1505 | 798 | 337 | 109 |
| 400 | 1796 | 1561 | 1179 | 627 | 258 | 78 |
| 450 | 1413 | 1207 | 873 | 466 | 185 | 49 |
| 500 | 1053 | 873 | 589 | 315 | 117 | 24 |
| 750 | 653 | 539 | 347 | 171 | 56 | 4 |
| 1000 | 465 | 384 | 241 | 111 | 35 | 0 |
| 1500 | 289 | 238 | 144 | 61 | 18 | 0 |
| 2000 | 206 | 170 | 100 | 39 | 12 | 0 |

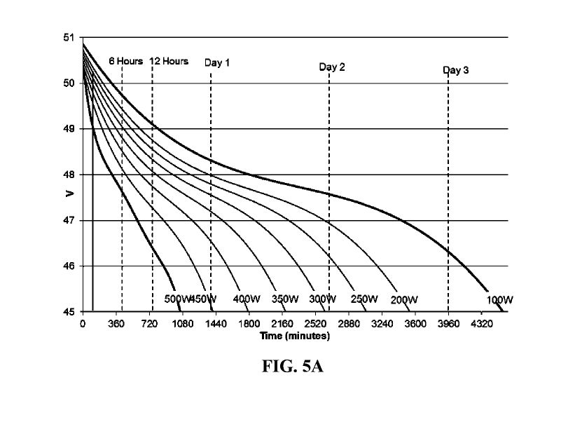

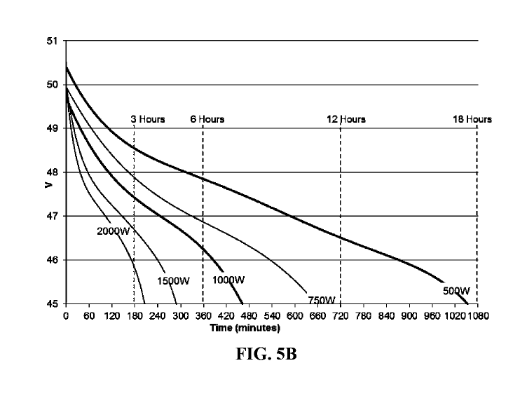

For each of these new load levels one can calculate again the least square fit polynomial that best fits the corresponding voltage versus time curve for the battery 10 in FIG. 1. The resulting voltage versus time curves for the low-end of the load spectrum (100 W to 500 W) are shown in FIG. 5A and the high end of the spectrum (500 W to 1000 W) are shown in FIG. 5B. These graphs clearly show how modeling battery discharge characterization in accordance with embodiments of the present invention addresses the non-linear nature of battery discharge.

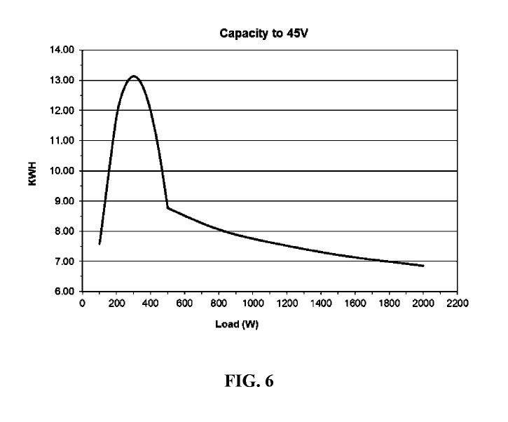

Using the above-described model for load and voltage over time, one can also calculate the battery capacity. For example, FIG. 6 shows battery capacity as a function of load for a battery starting full charged and discharged to 45V. The battery capacity may be calculated by integrating the load as a function of time up until the battery from fully charged to fully discharged, e.g., to 45 V. Assuming a constant load, this is just the product of the load and the time to reach fully discharged, which can be readily calculated from the data in Table III above.

FIG. 6 illustrates how much the storage capacity is dependent on the load. In this example, FIG. 6 shows that there is about 7.5 kWh of storage capacity at high loads. However, if the load is restricted to 300 W, the capacity increases to more than 13 KWH, almost double. This means that the particular battery system described by the graph in FIG. 6 is “optimized” for a load of 300 W. By way of comparison, this is approximately when a typical household forced-air furnace works at night. The drop in battery capacity at high loads in FIG. 6 makes sense, since higher load means higher current in the batteries, and higher current typically means more loss to heat in the batteries.

Embodiments of the present invention are not limited to generating models that are restricted to specific load levels and voltage levels, but also include generation of open models of battery behavior. Specifically, once the data has been gathered for a relatively small set of measurements the computer 16 to implement such an open model by fitting polynomials and power functions into ranges, basically yielding on the fly the type of data shown in Tables III, FIG. 5A, FIG. 5B, and FIG. 6. To limit the amount of data needed to generate the model, weighted fitting may be used, e.g., to generate voltage versus time data in between the known curves on the fly. Binary searches and recursive search algorithms may be used to speed up the calculations.

As an example of the use of binary searching to speed up calculations, consider an example in which it is desired to search for the time for a battery to discharge to an ending voltage V₂, from a given starting voltage V₁, under a given load as a function of time L(t), and suppose the function for voltage as a function of time under a given load L is known for the battery:

A naïve approach to calculating the result would be to specify some very small interval ε for the voltage (or load or time, depending on what is to be determined) and start scanning (calculating a value and looking for a match). Suppose that t₀ is the time at the origin. The program calculates the voltage for L(t₀). If the calculated voltage is greater than the target voltage v₂, the program can set t₁=t₀+ε and calculate a voltage for the new load value L(t₁). If the resulting voltage is still greater than the target end voltage V₂ the process can be repeated for t₂=t₀+2ε, t₃=t₀+3ε . . . until the time to reach the desired end voltage V₂ is determined.

Such a simple approach can take a long time. To speed up the process, a binary search may be used as follows. Consider two different times, e.g., t₀ at the origin (which may be where the voltage is equal to V₁) and t_{D} at the end of the voltage versus time curve. The program can calculate the voltage for both L(t₀) and L(t_{D}).

If the voltage for L(t_{D}) is greater than V₂ and the voltage for L(t₀) is smaller than V₂, the desired voltage is reached somewhere between t₀ and t_{D}, such as the middle point tₘ=(t₀+t_{D})/2.and now, if L(tₘ) is greater than V₂, the program may assume that the time to reach V₂ is between tₘ and t_{D}.

If the voltage for L(tₘ) is smaller than V₂, the program may assume that the time to reach V₂ is between t₀ and tₘ. This process may be repeated in a recursive fashion. For example, suppose the program determines that the voltage for L(t_{D}) is greater than V₂ and the voltage for L(t₀) is smaller than V₂. In this case a new intermediate time tᵢ may be determined, e.g., as tᵢ=(tₘ+t_{D})/2.

The program can then calculate the voltage for L(tᵢ) and compare it to V₂. Note that for this iteration, the search range is half the size of the previous search range. This process may be reiterated for subsequent intermediate values until tᵢ is less than some predetermined tolerance (e.g., the ε value for the naïve case). In some cases the program may allow a user to select the tolerance and thereby adjust the tradeoff between resolution (smaller tolerance) and speed of calculations (larger tolerance)

The result of a binary search is a logarithmic reduction on the number of steps required, and hence, the time to calculate. So if a naive solution requires (t_{D}−t₀)/ε steps, a recursive binary search requires Log((t_{D}−t₀)/ε) steps.

For example, if epsilon is one second, and the range t_{D}−t₀ is 3 days, the number of calculations can be reduced from about 256,000 calculations to about 17 steps at the most, and usually about 8-10 or so. In the case of the battery simulator, the calculations may be a bit more complex, e.g., if the L(t) is not known. However, this function may be approximated, e.g., by using weighting and curve fitting.

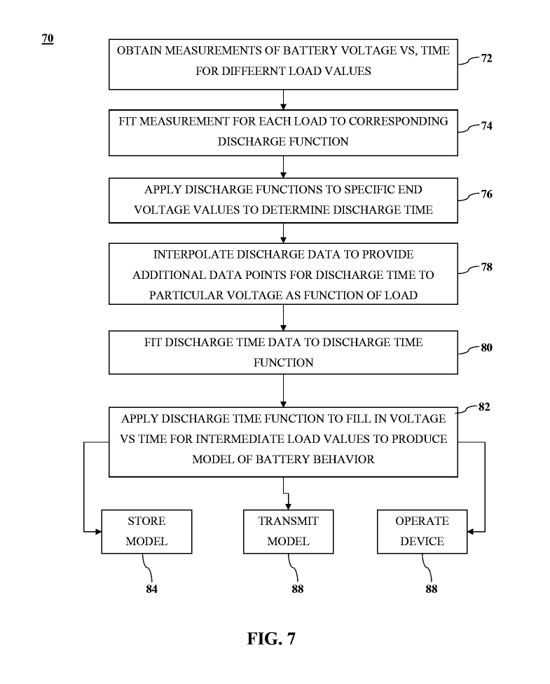

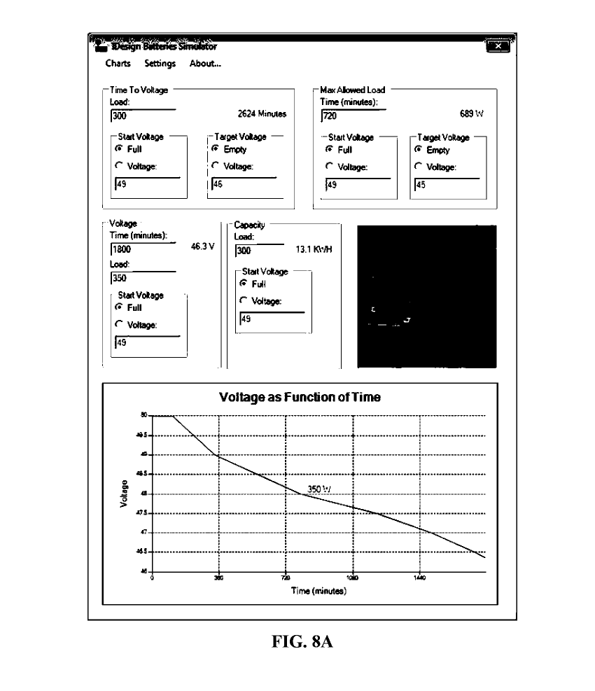

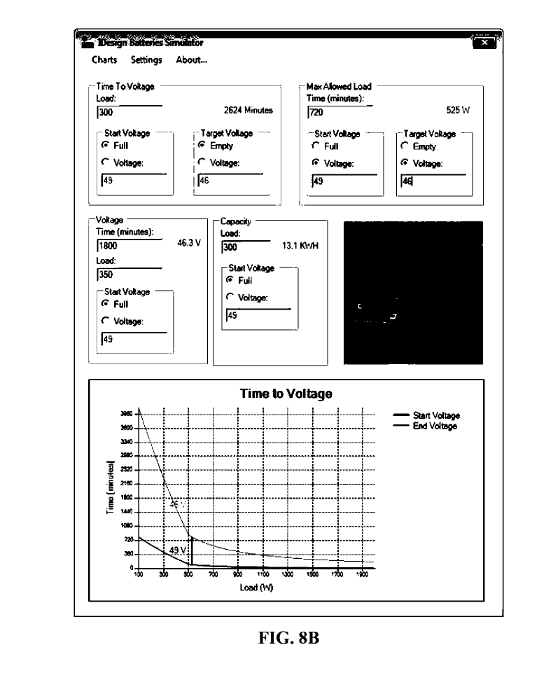

According to an embodiment of the present invention, modeling of battery behavior may be implemented in the form of computer program implemented in the form of a set of computer readable instructions, which may be embodied in a non-transitory computer-readable medium, such as a computer memory, disk drive, flash memory, CD-ROM, magnetic tape, and the like. FIG. 7 illustrates an example of the operation of a method 70 for automatically characterizing a storage battery in accordance with an embodiment of the present invention. The method 70 may be implemented in the form of a computer program, such as the program 15 shown in FIG. 1.

The method may begin by obtaining a plurality of sets of measurements of voltage on the storage battery versus time for a corresponding plurality of approximately constant load values as indicated at 72. The measurements may be obtained by performing experiments using the apparatus shown in FIG. 1. Alternatively, the data may be performed by a separate apparatus, converted into computer-readable data and then loaded into the computer 16 as data 17. The computer 16 may then automatically fit each set of measurements for a given corresponding load value to a corresponding discharge function as indicated at 74. The computer may then automatically apply the discharge functions to specific end voltage values for the battery to determine a set of discharge time data representing a time for the battery to discharge from a given initial value to a particular end voltage for a given load as indicated at 76.

Using the computer 16, the set of discharge data may be automatically interpolated to provide additional data points to produce a plurality of second sets of discharge time data for discharge time to a particular voltage as a function of load as indicated at 78. The computer 16 may then automatically fit each second set of discharge time data of discharge time to a particular voltage as a function of load to a discharge time function as indicated at 80. The discharge time function may then be automatically applied to fill in voltage versus time curves for intermediate load values to produce a computer model for time to a particular voltage as a function of load as indicated at 82. Specifically, voltage versus time data for different loads may be transformed into time versus load data for different voltages, as described above. Splines may be used to interpolate the measured time versus load data for given voltages to provide additional data points for intermediate load values, as described above. The resulting data for each voltage value may then be fit to a polynomial and/or power function using least-square regression to provide a set of functions that model the battery discharge behavior as described above.

There are a number of ways in which the resulting computer model may be used. For example, one can specify any load, start voltage and target voltage, and use the computer model to determine the time to reach the target voltage. Alternatively one may specify a load, start voltage and target time, and see what the target voltage will be at the target time.

Alternatively one can specify a load and target voltage and determine the battery capacity, e.g., as described above. In some embodiments, the program 15 may be configured to automatically produce and change charts reflecting the voltage during battery discharge as a function of time. Alternatively, one could input a given start voltage and end voltage, as well as a desired time and determine a maximum load the system can sustain. This can be useful, e.g., to determine the range (e.g., in miles or kilometers) for a battery-powered electric car. Other uses include determining how to optimize usage of battery storage for a solar powered system in order to avoid having to rely on power from a public electrical grid. The program 15 could even be configured to calculate a “distance” between the two voltage curves and even visualize it.

The resulting computer model may optionally be stored in computer readable form (e.g., as data 17) in a computer-readable medium (e.g., the memory of the computer 16), as indicated at 84. Alternatively, the computer model may optionally be transmitted in computer readable from over a network, as indicated at 86; or used to operate a battery-powered device, as indicated at 88.

There are a number of ways in which the computer model may be used to operate a storage battery or battery-powered device. For example, battery characterization may be obtained using the computer model as described above. A load, a start voltage and a target voltage may be entered into the computer program 15 and the program may determine a discharge time for the battery to discharge from the start voltage to the target voltage. The battery/device may then be operated by the computer 16 in accordance with the determined discharge time. Alternatively, a load, a start voltage and a target time may be entered into the program 15 and the program may determine what the target voltage will be for the battery at the target time. The battery/device may then be operated by the computer 16 in accordance with the determined target voltage. Furthermore, one could specify a load and a target voltage and determine a capacity of the battery. The battery/device may then be operated by the computer 16 in accordance with the determined capacity.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for characterizing a storage battery and automatically simulating its behavior, comprising:
a) obtaining a plurality of sets of measurements of voltage on the storage battery versus time for a corresponding plurality of approximately constant load values;
b) using a computer, automatically fitting each set of measurements for a given corresponding load value to a corresponding discharge function;
c) using a computer, automatically applying the corresponding discharge functions to specific end voltage values for the battery to determine a set of discharge time data representing a time for the battery to discharge from a given initial value to a particular end voltage for a given load;
d) using a computer, automatically interpolating the set of discharge data to provide additional data points to produce a plurality of second sets of discharge time data for discharge time to a particular voltage as a function of load;
e) fitting each second set of discharge time data of discharge time to a particular voltage as a function of load to a discharge time function;
f) using a computer, automatically applying the discharge time function to fill in voltage versus time curves for intermediate load values to produce a computer model for time to a particular voltage as a function of load; and either;
g) storing the model in computer readable form in a computer-readable medium; or
h) transmitting the model in computer readable from over a network; or
i) operating a battery-powered device coupled to a computer using the computer model.

2. The method of claim 1, wherein each discharge function is a least squares fit polynomial having coefficients calculated to at least fourteen decimal places.

3. The method of claim 1, wherein the discharge time function is a polynomial up to a cutoff load value and a power function beyond the cutoff load value.

4. The method of claim 1, further comprising determining a battery capacity as a function of load using the computer model.

5. The method of claim 1, wherein applying the discharge time function to fill in voltage versus time curves for intermediate load values includes determining a discharge time for the battery to discharge from the start voltage to a target voltage for a given load, start voltage and target voltage.

6. The method of claim 1, wherein applying the discharge time function to fill in voltage versus time curves for intermediate load values includes determining a target voltage for the battery for a given start voltage and target time.

7. The method of claim 1, wherein applying the discharge time function to fill in voltage versus time curves for intermediate load values includes determining a capacity of the battery for a given load and a target voltage.

8. A non-transitory computer readable medium having embodied therein computer readable instructions configured to implement a method for characterizing a storage battery upon execution of the instructions, wherein the instructions comprise:
a) one or more instructions configured to obtain a plurality of sets of measurements of voltage on the storage battery versus time for a corresponding plurality of approximately constant load values upon execution by a computer;
b) one or more instructions configured to fit each set of measurements for a given corresponding load value to a corresponding discharge function upon execution by a computer;
c) one or more instructions configured to apply the corresponding discharge functions to specific end voltage values for the battery to determine a set of discharge time data representing a time for the battery to discharge from a given initial value to a particular end voltage for a given load upon execution by a computer;
d) one or more instructions configured to interpolate the set of discharge data to provide additional data points to produce a plurality of second sets of discharge time data for discharge time to a particular voltage as a function of load upon execution by a computer;
e) one or more instructions configured to fit each second set of discharge time data of discharge time to a particular voltage as a function of load to a discharge time function upon execution by a computer;
f) one or more instructions configured to apply the discharge time function to fill in voltage versus time curves for intermediate load values to produce a computer model for time to a particular voltage as a function of load upon execution by a computer; and one or more instructions configured to either;
g) store the model in computer readable form in a computer-readable medium upon execution by a computer; or
h) transmit the model in computer readable from over a network upon execution by a computer; or
i) operate a battery-powered device coupled to a computer using the computer model upon execution by a computer.

9. A method for operating a storage battery, comprising:
obtaining battery characterization information for a given storage battery, wherein the battery characterization information is in the form of a plurality of fitted functions, wherein one or more of the fitted functions in the plurality are derived from measurements of voltage of the battery as a function of time by interpolating between two fitted functions obtained from the measurements;
entering the battery characterization information into a computer program running on a computer; and
(a) entering a load, a start voltage and a target voltage into the computer program and determining with the computer program discharge time for the battery to discharge from the start voltage to the target voltage and operating the battery in accordance with the determined discharge time; or
(b) entering a load, a start voltage and a target time into the program and determining with the computer program what the target voltage will be for the battery at the target time and operating the battery in accordance with the determined target voltage; or
(c) specifying a load and a target voltage and determine a capacity of the battery and operating the battery in accordance with the determined capacity.

10. The method of claim 1 wherein the one or more fitted functions include one or more polynomials or power functions.

11. The method of claim 2 wherein the one or more polynomials or power functions include one or more odd-order polynomials.

12. The method of claim 3 wherein the one or more odd-order polynomials include an odd number of coefficients, wherein each coefficient is determined to fourteen decimal places.
